(19) United States
(12) Patent Application Publication
(10) Pub. No.: US 2026/0023622 A1
(43) Pub. Date: Jan. 22, 2026

(54) SYSTEMS AND METHODS FOR PROCESS OPTIMIZATION USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Tirupathi Rao Madiya, Hyderabad (IN); Yellaiah Ponnameni, Hyderabad (IN); Preetivanti Marni, Hyderabad (IN); Srikrishna Kambala, Hyderabad (IN)

(73) Assignee: BANK OF AMERICA CORPORATION, CHARLOTTE, NC (US)

(21) Appl. No.: 18/779,241

(22) Filed: Jul. 22, 2024

(51) Int. Cl. G06F 9/50; G06F 16/906; G06F 16/908

(52) U.S. Cl. CPC G06F 9/5077; G06F 16/906; G06F 16/908; G06F 2209/503

(57) ABSTRACT

Systems, computer program products, and methods are described herein for process optimization using advanced computational models for data analysis and automated processing. The present disclosure is configured to collect metadata from a node associated with data, wherein the node is configured to process the data, and wherein the metadata comprises real-time parameters of the data; train an instantaneous process identifier (IPI) using the metadata, wherein the IPI comprises a deep learning neural network; analyze the metadata using a classification procedure, wherein the classification procedure determines resources needed to process the data; determine a processing node to process the data, wherein determining the processing node is based on the processing node's availability and the processing node's processing capabilities; and allocate resources to process the data, wherein allocating the resources comprises an instance-based allocation determined by the IPI.

### TECHNOLOGICAL FIELD

Example embodiments of the present disclosure relate to process optimization using advanced computational models for data analysis and automated processing.

### BACKGROUND

There are significant challenges associated with determining resource allocations associated with processing data. Applicant has identified a number of deficiencies and problems associated with conventional procedures to determine allocation of resources associated with processing data. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for process optimization using advanced computational models for data analysis and automated processing.

Embodiments of the present invention address the above needs and/or achieve other advantages by providing apparatuses (e.g., a system, computer program product, and/or other devices) and methods for process optimization using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention collects metadata from a node associated with data, wherein the node is configured to process the data, and wherein the metadata includes real-time parameters of the data. Further, in some embodiments, the present invention trains an instantaneous process identifier (IPI) using the metadata, wherein the IPI includes a deep learning neural network. Further, in some embodiments, the present invention analyzes the metadata using a classification procedure, wherein the classification procedure determines resources needed to process the data. Further, in some embodiments, the present invention determines a processing node to process the data, wherein determining the processing node is based on the processing node's availability and the processing node's processing capabilities. Further, in some embodiments, the present invention allocates resources to process the data, wherein allocating the resources includes an instance-based allocation determined by the IPI.

In some embodiments, the metadata further includes volumetric information, frequency information, source information, and historical information.

In some embodiments, the real-time parameters further include attributes configured to provide information about the data at a specific point in time, wherein the real-time parameters are configured to identify when the data was created, modified, or accessed. Further, in some embodiments, the real-time parameters are configured to identify the data's origination point, wherein the origination point includes where the data was created. Further, in some embodiments, the real-time parameters are configured to determine the data's processing latency, wherein the processing latency indicates processing time of the data. Further, in some embodiments, the real-time parameters are configured to determine the data's resource utilization, wherein the resource utilization measures usage of resources used to process the data.

In some embodiments, collecting the metadata further includes transforming the metadata from input data to vector data using distributed hash technology configured for training the IPI.

In some embodiments, training the IPI further includes comparing the metadata with historical metadata, determining the resources required to process the data based on the volumetric data, and determining, in real time, an allocation of resources needed to process the data.

In some embodiments, training the IPI further includes implementing a response trigger, wherein the response trigger configures the IPI for completing an objective associated with processing the data. Further, in some embodiments, the present invention defines an objective, wherein the objective creates a goal associated with the IPI. Further, in some embodiments, the present invention creates a response trigger, wherein the response trigger is based on the objective. Further, in some embodiments, the present invention refines the response trigger, wherein refining the response trigger includes comparing immediate benefits associated with the objective with long term benefits associated with the objective. Further, in some embodiments, the present invention implements the objective and the response trigger, wherein the IPI is configured to adopt the objective, and wherein the IPI is configured with the response trigger based on completion of the objective. Further, in some embodiments, the present invention reconfigures, using a feedback loop, the objective and the response trigger, wherein the reconfiguration of the objective and the response trigger is based on a current state of the IPI.

In some embodiments, the classification procedure includes an accuracy test, wherein the accuracy test determines an accuracy of the allocation of resources to process the data based on the metadata and the historical metadata.

In some embodiments allocating the resources to process the data further includes dynamically configuring the resource allocation in real time based on the accuracy test.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for process optimization using advanced computational models for data analysis and automated processing, in accordance with an embodiment of the disclosure;

FIG. 2 illustrates a process flow for process optimization using advanced computational models for data analysis and automated processing, in accordance with an embodiment of the disclosure; and

FIG. 3 illustrates an example embodiment of an instantaneous process identifier (IPI) in a network environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

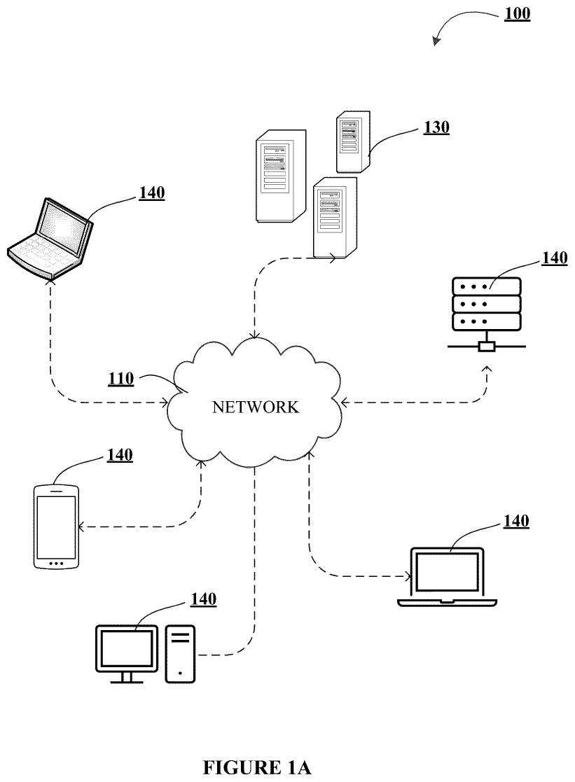

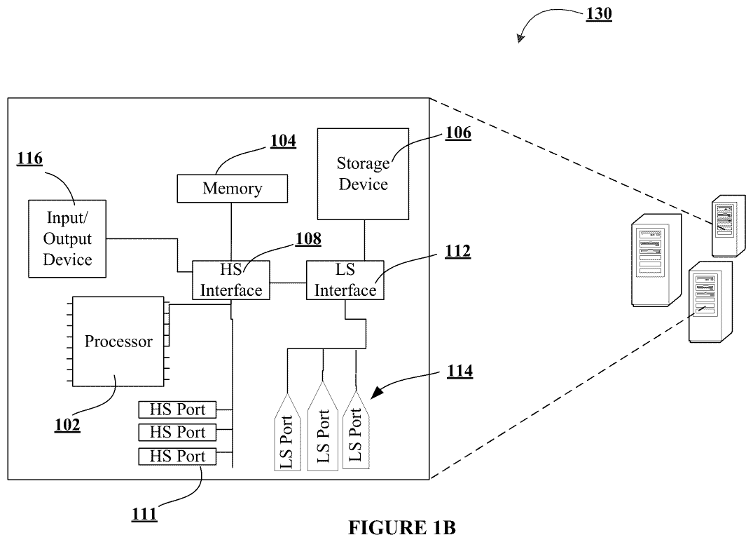

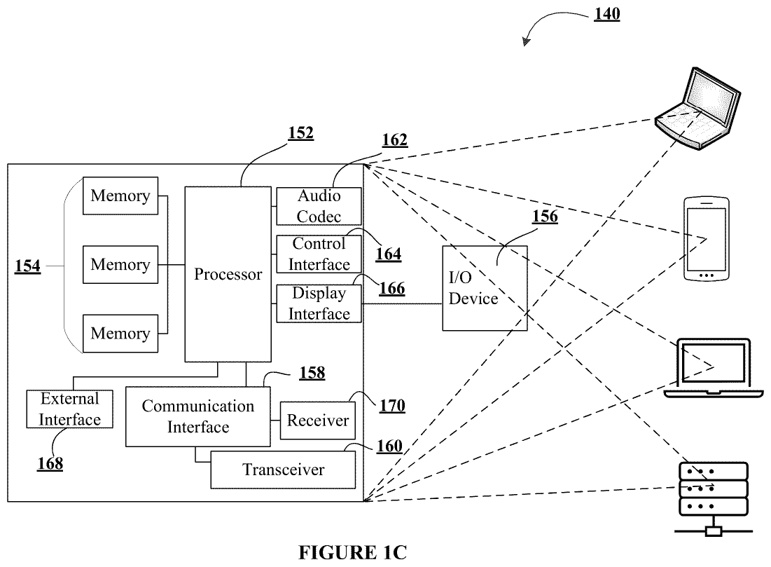

As used herein, a “resource” may generally refer to components related to computing or networking equipment. In some embodiments, a resource may include hardware resources, cloud computing resources, software resources, frameworks, libraries, services, miscellaneous tools, or the like. In an example embodiment, a resource may include a processing unit, a memory, a storage unit, networking components, communication circuitry, peripheral devices, or the like. In this way, a resource may include components similar to those shown in FIGS. 1A-1C. In some embodiments, a resource may be used to directly or indirectly process at least a portion of data, metadata, or the like. For example, a resource may be used to receive data (e.g., via a communication circuitry resource, similar to the HS port 111, LS port 114, or input/output device 116 of FIG. 1B), process data (e.g., via a processor resource similar to the processor 102 in FIG. 1B), store data (e.g., via a memory resource similar to the memory 104 or storage device 106 in FIG. 1B), or transfer data (e.g., similar to the HS interface 108 or LS interface 112 of FIG. 1B). Further, a resource may include a device (e.g., similar to end-point device 140) wherein the device is operatively coupled to the system 130. In this way, the system 130 may distribute resource(s) to an additional device, such as an end-point device 140.

In the modern world, entities and institutions rely heavily on their applications and networks to provide services for their customers. In many cases, these applications may be in a distributed network of applications. Further, the entities often implement a never-down approach to their applications, which place stringent requirements on the applications and supporting systems to maintain performance of the applications for their customers. Significant challenges surround such never-down approaches especially when a distributed network of applications is involved. In a conventional distributed network of applications, the types of issues that arise are often dynamic in nature without any evident solution existing to fix the dynamic issues. Further, the conventional distributed network of applications often cannot fix the issues in real time, which is required to support the never-down approach and to produce operational resiliency. Supporting the never-down approach in conventional systems, which translates to providing ceaseless coverage of the distributed network of applications, requires extreme levels of infrastructure development and human resource investment. This presents significant challenges during peak hours and in emergency situations. Therefore, an instantaneous process identifier (IPI) in a distributed network is provided.

The present disclosure provides creating a never-down approach, which includes operational resiliency in a distributed network arena. The system may include a real time data collector, analysis of instance-based data, strategic cerebral systems with deep neural networks, and cutting-edge technology framework to provide coverage of a distributed network of applications. In this way, the present disclosure may build a distributed hash technology network to perform analytics at each component (e.g., node). Distributed hash technology may include a decentralized system that stores data in a distributed network using key-value pairs. Each node associated with the network is responsible for a set of keys and their associated values, allowing for the node to efficiently retrieve the value associated with a given key. Keys may include unique identifiers which map to particular values. Further, mapping and maintaining the node network causes minimal disruption to the network as nodes are updated (e.g., added, edited, or deleted).

Further, the present disclosure may include the instantaneous process identifier (IPI) to create a strategic cerebral system, built on a deep logic neural network, to analyze real-time data parameters and system configurations. In this way, the IPI may create instance-based strategies for a given node or for the network as a whole. The instance-based strategies may be ran through accuracy tests in a simulated distributed network to determine an appropriate strategy for implementation on the network. In addition, the instance-based strategies may be deployed through autonomous nodes in a distributed network to update system configurations and parameters to execute processes. In this way, the automation capabilities may execute the instance-based strategies in a distributed network, creating the never-down approach. For example, the present disclosure may understand the instantaneous behavior of an application or server to identify asymmetric issues and resolve them via instance-based strategies.

In some embodiments, data may be collected in real time from various nodes, components, and the like. The data may be converted from input text to vector representation using distributed hash technology. In this way, the vector representation of the data may allow for the IPI to analyze and configure the input data. Further, the data may be used to train the IPI, wherein the IPI may be trained using metadata associated with the data (e.g., data collected from nodes). The training may include using response triggers for the IPI that may configure the IPI for configuring the nodes in a way that reduces resources consumed during processing of the data.

What is more, the present disclosure provides a technical solution to a technical problem. As described herein, the technical problem includes issues associated with dynamic issues stemming from a distributed network of applications implemented to provide a never-down approach. The technical solution presented herein allows for using an instantaneous process identifier (IPI) to provide instance-based strategies for nodes to determine real time solutions for issues that arise. In particular, IPI is an improvement over existing solutions to the problem of downtime associated with conventional problem solving techniques for distributed networks, (i) with fewer steps to achieve the solution, thus reducing the amount of computing resources, such as processing resources, storage resources, network resources, and/or the like, that are being used (e.g., automating instance-based strategy configurations using the IPI), (ii) providing a more accurate solution to problem, thus reducing the number of resources required to remedy any errors made due to a less accurate solution (e.g., training the IPI using response triggers to create accurate solutions), (iii) removing manual input and waste from the implementation of the solution, thus improving speed and efficiency of the process and conserving computing resources (e.g., using the real-time problem solving capabilities of the IPI to maintain network performance), (iv) determining an optimal amount of resources that need to be used to implement the solution, thus reducing network traffic and load on existing computing resources (e.g., training the IPI using response triggers, wherein the response triggers configure the IPI for efficiencies gained via reduction in resource allocation where possible). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the IPI as described herein is a solution to the problem of maintaining operational networks by providing solutions to dynamic problems arising in real time, often during peak hours and emergency situations. Further, the IPI (e.g., the system 130 as described herein) may be characterized as identifying a specific improvement in computer capabilities and/or network functionalities in response to the IPI's integration to existing devices, software, applications, and/or the like. In this way, the IPI improves the capability of a system to maintain operational resiliency of a network by providing dynamic, real-time solutions using instance-based configurations and real-time data parameters. Further, the IPI improves the functionality of networks in response to reducing the resources consumed by the system (e.g., network resources, computing resources, memory resources, and/or the like).

FIGS. 1A-IC illustrate technical components of an exemplary distributed computing environment 100 for process optimization using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

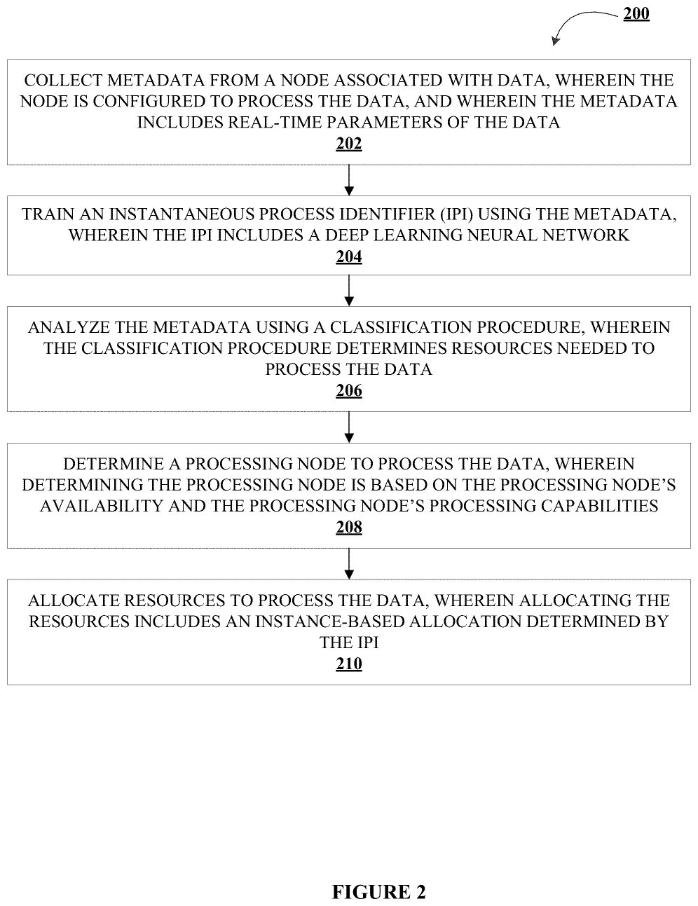

FIG. 2 illustrates a process flow for process determination using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an instantaneous process identifier (e.g., similar to one or more of the systems described herein with respect to FIGS. 1A-1C) may perform one or more of the steps of process flow 200. For example, a process determination using advanced computational models for data analysis and automated processing (e.g., the system 130 described herein with respect to FIGS. 1A-1C) may perform the steps of process flow 200.

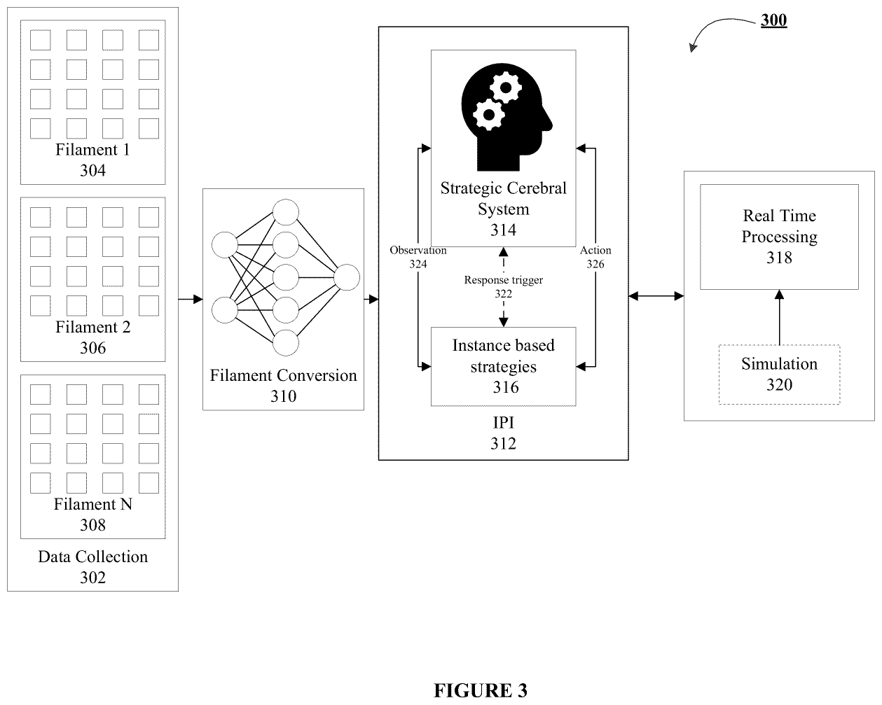

As shown in block 202, the process flow 200 of this embodiment includes collecting metadata from a node associated with data, wherein the node is configured to process the data, and wherein the metadata includes real-time parameters of the data. In some embodiments, and as shown in FIG. 3, the data collection 302 may include collecting data from filaments. The filaments may include a filament 1 304, a filament 2 306, or a filament N 308, with filament N 308 being any number of filaments. The filaments may provide a stream of data for the system (e.g., the system 130 as described herein) to carry out the steps as described herein. In some embodiments, the filaments may include different types of materials, such as fiber optics, copper medium, or the like. In this way, the filaments may provide a connection point for the system to collect the data associated with the filaments. Further, the filaments may be operatively coupled to the system and to a node, component, hardware, software, an additional system, a third party system, or the like where the data is collected from.

In some embodiments, the metadata further includes volumetric information, frequency information, source information, and historical information. The metadata may provide analytical data, background data, or the like associated with the data collected by the system. For example, and as shown in FIG. 3, the data collected via the data collection 302 may include the metadata. In some embodiments, the metadata's volumetric information may include a volume of data associated with the data collection 302. In this way, the volumetric information may indicate a size, memory usage, storage requirement, or the like associated with the data coming from the filaments. In some embodiments, the frequency information may include a frequency associated with the data. In this way, the frequency information may indicate how frequent the data (or the type of data) is collected via the data collection 302, as shown in FIG. 3. In some embodiments, the source information may include a source of the data collected via the data collection 302. The source information may indicate a particular source from which the data originates, a source from which the data is transmitted, or the like. For example, the source information may provide information regarding where the data has originated, or information regarding where the data was transmitted from. Further, in some embodiments, the historical information may include information associated with the data's history, such as how it has been configured, reconfigured, manipulated, a transaction path of the data, or the like.

In some embodiments, the real-time parameters further include attributes configured to provide information about the data at a specific point in time. Further, in some embodiments, the real-time parameters may be configured to identify when the data was created, modified or accessed. In this way, the real-time parameters may include a timestamp (e.g., when the data was created, modified, or accessed). At its initial creation, the data may be given a timestamp, which may be modified when the data is modified or accessed. The timestamp may be updated to reflect the changes to provide an accurate history of updates.

Further, in some embodiments, the real-time parameters may be configured to identify the data's origination point, wherein the origination point includes where the data was created. In some embodiments, the data's origination point may be included in the timestamp, as described above. In this way, the data's origination point may include the conditions under which the data was first generated. Further, the data's origination point may ensure proper data validation and authentication procedures, provide traceability, and enhance data management processes of the system.

Further, in some embodiments, the real-time parameters may be configured to determine the data's processing latency, wherein the processing latency indicates processing time of the data. The processing latency may include the time interval between when the data is received and when the data is fully processed and ready for use. The system may use this information to determine node assignments, configurations of data streams, resource allocations, and the like. Further, the processing latency may highlight issues within the data processing operations, such as limitations of the system, bottlenecks, delays, and the like. In this way, the IPI may be able to determine a location where processing of the data may be improved.

Further, in some embodiments, the real-time parameters may be configured to determine the data's resource utilization, wherein the resource utilization measures usage of resources used to process the data. The resource utilization may include metrics such as CPU usage, GPU usage, memory consumption, input/output operations, and the like. In this way, the resource utilization may show the resources consumed during processing of the data. Further, resource-intensive tasks may be viewed via the resource utilization parameter, allowing the system to identify and configure the processes associated with the resource-intensive tasks. For example, the resource utilization may help the IPI to create an instance-based strategy relating to expanding scalability of operations via reconfiguring the resources utilized during processing of the data.

In some embodiments, collecting the metadata further includes transforming the metadata from input data to vector data using distributed hash technology configured for training the IPI. In some embodiments, distributed hash technology (DHT) may include implementing a decentralized, scalable, and efficient data management environment. In this way, the DHT may distribute the data associated with the system evenly across the network of nodes. Further, with DHT, the system may balance data assignment to the associated nodes in a dynamic fashion when nodes join or leave the network. The incoming metadata from the data collection 302, as shown in FIG. 3, may be converted via the filament conversion 310 to transform the metadata into vector data. In this way, the vector data may be used in with the DHT to allow the system (e.g., the system 130) to reliably analyze and configure the metadata and associated data. In some embodiments, the filament conversion 310 may include using the DHT to generate a key for the data, metadata, or the like. Further, the key may be hashed to produce a hash value, and the hash value may be used to find a node to which the data is transferred. For data retrieval, the system may hash the key to find the node or nodes where the data was transmitted and query the node for the value associated with the key. In some embodiments, the data hashed and transferred to the nodes may be in any form (e.g., text, binary, structured data, unstructured data, or the like).

As shown in block 204, the process flow 200 of this embodiment includes training an instantaneous process identifier (IPI) using the metadata, wherein the IPI includes a deep learning neural network. The deep learning neural network may include multiple layers between the input and output layers, wherein the layers may be designed to automatically learn data representations via abstraction layers. In this way, the deep learning neural network may perform complex tasks, such as determining instance-based strategies, real time processing, and the like. The deep learning neural network (e.g., the IPI) may include the one or more nodes, wherein the nodes may receive the data, apply a weight, add a bias, pass the result to activation functions, produce results, and the like. The nodes may be organized into layers, wherein the layers perform different operations such as receiving the data (e.g., via the input layer), performing computations (e.g., via the intermediate hidden layers), and producing final results (e.g., via the output layer). In some embodiments, the IPI may include different deep learning neural network architectures, such as feedforward neural networks, convolutional neural networks, recurrent neural networks, or the like.

In some embodiments, the weights and biases may transform the input data fed to the IPI. Activation functions may be used to allow the IPI to model complex relationships between the nodes, the data, the metadata, and the like. Loss functions may also be used to optimize and determine further process improvements by measuring between a predicted output and an actual target. Further, optimization algorithms may be used to update the weights and biases associated with the nodes, which may be used for several iterations to determine an appropriate output. For example, the resource allocation determination may be an output of the IPI, and an optimization algorithm may be used to further improve the process of determining appropriate resource allocations.

In some embodiments, training the IPI further includes comparing the metadata with historical metadata. The historical metadata may include metadata associated with metadata received at a previous iteration, configuration, or the like. In this way, the system may keep record of the data that has flowed through the system. The historical metadata may include the same metrics and real-time parameters, as discussed above. In this way, comparing the metadata with the historical metadata may include determining differences between the two sets. For example, the comparison may indicate that the current metadata shows a higher volume (e.g., volumetric information) of data as compared with the historical metadata. The IPI may use the current metadata's increased volumetric information during its training to allocate resources configured to process the data.

In some embodiments, training the IPI further includes determining the resources required to process the data based on the volumetric data. Further, in some embodiments, training the IPI further includes determining, in real time, an allocation of resources needed to process the data. The determination of the allocation of resources in real time may include using the metadata to determine how many resources are required to process the data. In this way, training the IPI may include determining which components (e.g., processors, memory, input/output circuitry, communications circuitry, or the like) should be used to process the data.

In some embodiments, training the IPI further includes implementing a response trigger, wherein the response trigger configures the IPI for completing an objective associated with process the data. The response trigger may include at least a portion of program code, application, or the like that encourages the IPI to perform certain tasks. Further, in some embodiments, the system may define an objective, wherein the objective creates a goal associated with the IPI. For example, the goal may be included in the at least portion of the program code and may be implemented in the IPI based on the distribution of resources used to process the data. As shown in FIG. 3, the IPI 312 may include a strategic cerebral system 314 that determines instance based strategies 316. Further, the strategic cerebral system 314 may include a deep neural network (as discussed above). As shown in FIG. 3, the strategic cerebral system 314 may be configured with a response trigger 322 for certain instance based strategies 316, depending on if those strategies align with the objective. Further, the IPI 312 may include performing an observation 324 and/or an action 326 associated with one or more instance based strategies 316. For example, the observation 324 and action 326 may prompt the IPI 312 to, based on its training, generate resource allocations to process the data in an efficient manner. In some embodiments, the instance based strategies 316 may include distributing or re-distributing a node's assignment, wherein the assignment is associated with processing the current data stream. Further, the instance-based strategies 316 may be based on the metadata of the data.

Further, in some embodiments, the system may create a response trigger, wherein the response trigger is based on the objective. The response trigger may include a reinforcement learning objective to direct the system (e.g., the system 130 as described herein) to perform in a certain manner. The response trigger may include a positive response given to the IPI to encourage certain desired behavior of the IPI. In some embodiments, the response trigger may include the objective for the IPI, while the IPI may need to determine how to reach the objective. For example, if the response trigger includes an objective for the IPI to reduce the amount of resources allocated to a particular dataset without reducing the processing quality, the IPI may determine its own solution for how to do so. Similarly, and in some embodiments, the response trigger may include a negative response to discourage undesirable behavior of the IPI. The negative response may discourage certain behavior the IPI used while not achieving the objective.

The response trigger may include different configuration methods to encourage the IPI to behave in certain manners depending on the task or objective. For example, immediate rewards may be immediately configure the IPI after an action is taken. In this way, the immediate rewards may configure, in real time, the IPI after it has completed a certain objective or performed a task. Further, cumulative rewards may be rewards that accumulate over a period of time, over a sequence of tasks or objectives, or the like. In this way, the cumulative rewards may be used to direct an overall behavior of the IPI over a longer period. Further, partial rewards may guide the IPI towards completion of an objective if it has partially completed a task during an objective. The partial rewards may be used while the IPI is completing an objective to encourage or discourage certain behaviors.

Further, in some embodiments, the system may refine the response trigger, wherein refining the response trigger includes comparing immediate benefits associated with the objective with long term benefits associated with the objective. Refining the response trigger may include refining the objective associated with the response trigger. In this way, the response trigger, rewards, objective, or the like may be modified (e.g., refined) based on the IPI's performance.

In some embodiments, the system may implement the objective and the response trigger, wherein the IPI is configured to adopt the objective, and wherein the IPI is configured with the response trigger based on completion of the objective. In this way, the IPI may be rewarded with a positive reward or a negative reward depending on the objective completion status, the actions the IPI took during completion of the objective, or the like.

In some embodiments, the system may reconfigure, using a feedback loop, the objective and the response trigger, wherein the reconfiguration of the objective and the response trigger is based on a current state of the IPI. In some embodiments, the feedback loop may include refining the response trigger, the rewards, or the objective. The current state of the IPI may indicate how the reconfiguration should occur. For example, if the current state of the IPI indicates the IPI is underperforming based on the current response trigger, the response trigger may be reconfigured to better suit the operation of the IPI.

As shown in block 206, the process flow 200 of this embodiment includes analyzing the metadata using a classification procedure, wherein the classification procedure determines resources needed to process the data. In some embodiments, the classification procedure may indicate which type of resources are needed to process the data, how many resources are needed to process the data, or the like. The classification procedure may assist with the IPI's determination of how to distribute resources to the available nodes. For example, if a first node is better situated to process data and a second node is better situated to store data until it is processed, the classification procedure may classify the roles of the nodes for use by the IPI.

In some embodiments, the classification procedure includes an accuracy test, wherein the accuracy test determines an accuracy of the allocation of resources to process the data based on the metadata and the historical metadata. The accuracy test may determine how well the IPI distributed resources associated with processing the data. For example, the historical metadata and the metadata (e.g., current metadata) may be used to determine the number of resources conserved during the distribution of resources. Further, the response trigger may include the accuracy test may be used in conjunction with the response trigger to create rewards and objectives for the IPI.

In some embodiments, allocating the resources to process the data further includes dynamically configuring the resource allocation in real time based on the accuracy test. For example, as shown in FIG. 3, the IPI 312 may perform real time processing 318, wherein the real time processing 318 includes dynamically configuring the resource allocation. In some embodiments, the real time processing 318 may be based on the accuracy test. The dynamic configuration of the resource allocation may include configuring or reconfiguring assignment of data to the nodes via real time processing 318.

As shown in block 208, the process flow 200 of this embodiment includes determining a processing node to process the data, wherein determining the processing node is based on the process node's availability and the processing node's processing capabilities. The processing node may include a node that has the capability to process the data. The processing node may be chosen based on the availability of the node, which may include an indication of the node's current assignments, the node's future assignments, the node's maintenance schedule, the node's overall health, and the like. Further, the processing node's capabilities may indicate the resources available to the node to process the data.

In some embodiments, a processing node may include a plurality of processing nodes, wherein the plurality of processing nodes may be operatively coupled to process the data. The operative coupling of the processing nodes may include wired or wireless connections between the nodes for them to transfer data between each other. The processing nodes may include selecting the processing nodes based on their configurations and ability to process the data. The processing nodes may directly or indirectly process the data (e.g., a node may be chosen for its memory capabilities while another may be chosen for its processing capabilities).

As shown in block 210, the process flow 200 of this embodiment includes allocating resources to process the data, wherein allocating the resources includes an instance-based allocation determined by the IPI. The instance-based allocation may include a configuration or reconfiguration of nodes or processing nodes associated with processing the data. In this way, the instance-base allocations may include the instance-based strategies, as discussed above.

In some embodiments, the instance-based allocations may involve pre-computing instances and storing them to a memory (e.g., similar to memory 104 as shown in FIG. 1B). In this way, the system may determine instances prior to receiving the data and metadata and, when the data and metadata are received, determining resource allocations based on the pre-computed instances.

Further, in some embodiments, the instance-based allocations may be based on simulations, wherein the simulations simulate the resource allocations determined via the instance-based allocation. For example, as shown in FIG. 3, the simulation 320 may be used in combination with the real time processing 318 of the data. Further, the simulation 320 may be used by the IPI 312 to determine instance based strategies 316. In this way, the system (e.g., the system 130 as described herein) may generate a simulation, wherein the simulation is based on the nodes associated with the system, the data associated with the system, and the metadata associated with the system. The simulation may simulate at least an instance in which data is in the system. The system may make predictions by using the simulation to simulate different resource allocations. Further, the simulation 320 may cause the IPI 312 to be given a simulated reward (e.g., similar to the reward 322). The simulation may provide the system with one or more scenarios, wherein the scenarios include different allocations of resources to process the data. The simulation may consider the metadata associated with the data, the historical metadata associated with the data, and the like in order to generate the simulations.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for process determination using advanced computational models for data analysis and automated processing, the system comprising:
a processing device;
a non-transitory storage device containing instructions when executed by the processing device, causes the processing device to perform the steps of:
collect metadata from a node associated with data, wherein the node is configured to process the data, and wherein the metadata comprises real-time parameters of the data;
train an instantaneous process identifier (IPI) using the metadata, wherein the IPI comprises a deep learning neural network;
analyze the metadata using a classification procedure, wherein the classification procedure determines resources needed to process the data;
determine a processing node to process the data, wherein determining the processing node is based on the processing node's availability and the processing node's processing capabilities; and
allocate resources to process the data, wherein allocating the resources comprises an instance-based allocation determined by the IPI.

2. The system of claim 1, wherein the metadata further comprises volumetric information, frequency information, source information, and historical information.

3. The system of claim 1, wherein the real-time parameters further comprise attributes configured to provide information about the data at a specific point in time, and wherein the real-time parameters are configured to:
identify when the data was created, modified, or accessed;
identify the data's origination point, wherein the origination point comprises where the data was created;
determine the data's processing latency, wherein the processing latency indicates processing time of the data; and
measures usage of resources used to process the data.

4. The system of claim 1, wherein collecting the metadata further comprises transforming the metadata from input data to vector data using distributed hash technology configured for training the IPI.

5. The system of claim 1, wherein training the IPI further comprises:
comparing the metadata with historical metadata;
determining the resources required to process the data based on the volumetric data; and
determining, in real time, an allocation of resources needed to process the data.

6. The system of claim 1, wherein training the IPI further comprises implementing a response trigger, wherein the response trigger configures the IPI for completing an objective associated with processing the data, and wherein the processing device is further configured to:
define an objective, wherein the objective creates a goal associated with the IPI;
create a response trigger, wherein the response trigger is based on the objective;
refine the response trigger, wherein refining the response trigger comprises comparing immediate benefits associated with the objective with long term benefits associated with the objective;
implement the objective and the response trigger, wherein the IPI is configured to adopt the objective, and wherein the IPI is configured via the response trigger based on completion of the objective; and
reconfigure, using a feedback loop, the objective and the response trigger, wherein the reconfiguration of the objective and the response trigger is based on a current state of the IPI.

7. The system of claim 1, wherein the classification procedure comprises an accuracy test, wherein the accuracy test determines an accuracy of the allocation of resources to process the data based on the metadata and the historical metadata.

8. The system of claim 7, wherein allocating the resources to process the data further comprises dynamically configuring the resource allocation in real time based on the accuracy test.

9. A computer program product for process determination using advanced computational models for data analysis and automated processing, the computer program product comprising a non-transitory computer-readable medium comprising code causing an apparatus to:
collect metadata from a node associated with data, wherein the node is configured to process the data, and wherein the metadata comprises real-time parameters of the data;
train an instantaneous process identifier (IPI) using the metadata, wherein the IPI comprises a deep learning neural network;
analyze the metadata using a classification procedure, wherein the classification procedure determines resources needed to process the data;
determine a processing node to process the data, wherein determining the processing node is based on the processing node's availability and the processing node's processing capabilities; and
allocate resources to process the data, wherein allocating the resources comprises an instance-based allocation determined by the IPI.

10. The computer program product of claim 9, wherein the metadata further comprises volumetric information, frequency information, source information, and historical information.

11. The computer program product of claim 9, wherein the real-time parameters further comprise attributes configured to provide information about the data at a specific point in time, and wherein the real-time parameters are configured to:
identify when the data was created, modified, or accessed;
identify the data's origination point, wherein the origination point comprises where the data was created;
determine the data's processing latency, wherein the processing latency indicates processing time of the data; and
measures usage of resources used to process the data.

12. The computer program product of claim 9, wherein collecting the metadata further comprises transforming the metadata from input data to vector data using distributed hash technology configured for training the IPI.

13. The computer program product of claim 9, wherein training the IPI further comprises:
comparing the metadata with historical metadata;
determining the resources required to process the data based on the volumetric data; and
determining, in real time, an allocation of resources needed to process the data.

14. The computer program product of claim 9, wherein training the IPI further comprises implementing a response trigger, wherein the response trigger configures the IPI for completing an objective associated with processing the data, and wherein the code further causes the apparatus to:
define an objective, wherein the objective creates a goal associated with the IPI;
create a response trigger, wherein the response trigger is based on the objective;
refine the response trigger, wherein refining the response trigger comprises comparing immediate benefits associated with the objective with long term benefits associated with the objective;
implement the objective and the response trigger, wherein the IPI is configured to adopt the objective, and wherein the IPI is configured with the response trigger based on completion of the objective; and
reconfigure, using a feedback loop, the objective and the response trigger, wherein the reconfiguration of the objective and the response trigger is based on a current state of the IPI.

15. The computer program product of claim 1, wherein the classification procedure comprises an accuracy test, wherein the accuracy test determines an accuracy of the allocation of resources to process the data based on the metadata and the historical metadata.

16. The computer program product of claim 15, wherein allocating the resources to process the data further comprises dynamically configuring the resource allocation in real time based on the accuracy test.

17. A method for determination using advanced computational models for data analysis and automated processing, the method comprising:
collecting metadata from a node associated with data, wherein the node is configured to process the data, and wherein the metadata comprises real-time parameters of the data;
training an instantaneous process identifier (IPI) using the metadata, wherein the IPI comprises a deep learning neural network;
analyzing the metadata using a classification procedure, wherein the classification procedure determines resources needed to process the data;
determining a processing node to process the data, wherein determining the processing node is based on the processing node's availability and the processing node's processing capabilities; and
allocating resources to process the data, wherein allocating the resources comprises an instance-based allocation determined by the IPI.

18. The method of claim 17, wherein the metadata further comprises volumetric information, frequency information, source information, and historical information.

19. The method of claim 17, wherein the real-time parameters further comprise attributes configured to provide information about the data at a specific point in time, and wherein the real-time parameters are configured to:
identify when the data was created, modified, or accessed;
identify the data's origination point, wherein the origination point comprises where the data was created;
determine the data's processing latency, wherein the processing latency indicates processing time of the data; and
determine the data's resource utilization, wherein the resource utilization measures usage of resources used to process the data.

20. The method of claim 17, wherein collecting the metadata further comprises transforming the metadata from input data to vector data using distributed hash technology configured for training the IPI.
